(19) United States
(12) Patent Application Publication
(10) Pub. No.: US 2026/0274558 A1
(43) Pub. Date: Sep. 17, 2026

(54) RETENTION AND SEALING MECHANISM TRASH BAG DEVICE

(71) Applicant: Marcus Owes, Mobile, AL (US)

(72) Inventor: Marcus Owes, Mobile, AL (US)

(21) Appl. No.: 19/562,100

(22) Filed: Mar. 10, 2026

Related U.S. Application Data
(60) Provisional application No. 63/771,050, filed on Mar. 13, 2025.

(51) Int. Cl. B65F 1/00

(52) U.S. Cl. CPC B65F 1/002; B65F 1/0026; B65F 2210/129; B65F 2210/167

(57) ABSTRACT

A retention and sealing mechanism trash bag device is provided. The device is comprised of a trash bag that comprises a retention and sealing mechanism that includes an elastic band routed through a locking member. The elastic band is constructed from elastomeric materials such as natural rubber, silicone, thermoplastic elastomers, or polyurethane blends, and may include tactile members for engagement with the locking member. The locking member may comprise a unidirectional ratcheting system, friction-lock housing, or toothed engagement mechanism to maintain the elastic band at a fixed tension. The elastic band may be routed through an external attachment fastener or enclosed in an internal peripheral sleeve with exit points to allow user access to the locking member and band end. The mechanism is operable to compress the bag body radially against the receptacle rim for retention and to cinch the bag opening during removal for sealing.

### CROSS-REFERENCE TO RELATED APPLICATION

The present application claims priority to, and the benefit of, U.S. Provisional Application No. 63/771,050, which was filed on Mar. 13, 2025, and is incorporated herein by reference in its entirety.

### FIELD OF THE INVENTION

The present invention relates generally to the field of trash bags. More specifically, the present invention relates to a trash bag featuring a retention and sealing mechanism with an elastic band routed through a locking member, operable to secure the bag around a receptacle rim and cinch the bag opening for sealing during removal. Accordingly, the present disclosure makes specific reference thereto. Nonetheless, it is to be appreciated that aspects of the present invention are also equally applicable to other like applications, devices, and methods of manufacture.

### BACKGROUND

Improper retention of trash bags within receptacles continues to present practical and hygienic challenges in residential, commercial, and industrial waste management settings. Conventional trash bags frequently collapse inward when waste is deposited, leading to the accumulation of garbage directly inside the trash container. This occurrence necessitates manual intervention to retrieve and reposition the bag, which can be unsanitary and inconvenient for users. Additionally, many traditional trash bags lack mechanisms for controlled sealing, resulting in odor release and increased exposure to potentially hazardous waste materials. The structural limitations of these bags often result in tearing when overfilled or stressed, compounding the risk of spills and contamination.

Therefore, there exists a long-felt need in the art for a retention and sealing mechanism trash bag device that prevents slippage of the bag into the receptacle during use. There also exists a long-felt need in the art for a retention and sealing mechanism trash bag device that facilitates reliable and hygienic sealing of the bag during removal. Moreover, there exists a long-felt need in the art for a retention and sealing mechanism trash bag device that enhances user convenience and waste containment.

The subject matter disclosed and claimed herein, in one embodiment thereof, comprises a retention and sealing mechanism trash bag device. The device is comprised of a trash bag that comprises a retention and sealing mechanism that includes an elastic band routed through a locking member. The elastic band is constructed from elastomeric materials such as natural rubber, silicone, thermoplastic elastomers, or polyurethane blends, and may include tactile members for engagement with the locking member. The locking member may comprise a unidirectional ratcheting system, friction-lock housing, or toothed engagement mechanism to maintain the elastic band at a fixed tension. The elastic band may be routed through an external attachment fastener or enclosed in an internal peripheral sleeve with exit points to allow user access to the locking member and band end. The mechanism is operable to compress the bag body radially against the receptacle rim for retention and to cinch the bag opening during removal for sealing. A method of use includes inserting the bag into a receptacle, tightening the mechanism via pulling an end of the band through the locking member to retain the bag around the receptacle, cinching the bag opening after filling, and optionally tying the bag shut for final disposal.

In this manner, the retention and sealing mechanism trash bag device of the present invention accomplishes all the foregoing objectives and provides a trash bag that prevents the bag from falling into the trash receptacle and enables controlled and hygienic sealing upon removal. More specifically, the elastic band and locking member combination ensures a consistent and adjustable fit around varying receptacle geometries, reducing the need for manual repositioning and improving user experience. The ability to cinch and seal the bag at the point of removal further minimizes odor release and potential exposure to waste, enhancing hygiene and safety. By integrating these features into a unified trash bag design, the device resolves longstanding issues in waste containment with practical and efficient means.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a retention and sealing mechanism trash bag device. The device is a trash bag configured to provide secure attachment to a trash receptacle rim and enable efficient sealing during removal, thereby improving user convenience, hygiene, and waste management. The device is comprised of a trash bag body further comprised of a retention and sealing mechanism configured to secure the trash bag to the receptacle rim and facilitate cinching for closure.

More specifically, the mechanism includes an elastic band, wherein a first end of the elastic band is routed through a locking member configured to retain the band at a selected tension. During installation, the elastic band is tensioned through the locking member to compress the trash bag body against the receptacle rim, preventing displacement during use. During removal, the band is further tensioned to cinch the opening of the bag and seal the contents of the bag. The mechanism may also serve as a grip aid during extraction. After removal, the trash bag may be tied for additional closure.

In one embodiment, a portion of the elastic band is externally affixed to the body using a fastener comprising a bonding agent, thermal seal, adhesive, or mechanical stitching. In another embodiment, the band is routed through an internal pocket integrated along the periphery of the body, with exit openings that expose the locking member and band end for user access.

The invention further includes a method of use comprising the steps of providing the trash bag with an integrated retention and sealing mechanism, positioning the bag within a receptacle, tensioning the band through the locking member to secure the bag, cinching the opening during removal to seal contents, gripping the mechanism to extract the bag, and optionally tying the bag shut prior to disposal.

Accordingly, the retention and sealing mechanism trash bag device of the present invention is particularly advantageous as it provides a trash bag that prevents the bag from falling into the trash receptacle and enables controlled and hygienic sealing upon removal. More specifically, the elastic band and locking member combination ensures a consistent and adjustable fit around varying receptacle geometries, reducing the need for manual repositioning and improving user experience. The ability to cinch and seal the bag at the point of removal further minimizes odor release and potential exposure to waste, enhancing hygiene and safety. By integrating these features into a unified trash bag design, the device overcomes the limitations and issues of existing trash bags known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a retention and sealing mechanism trash bag device of the present invention while open in accordance with the disclosed architecture;

FIG. 2 illustrates a front view of one potential embodiment of a retention and sealing mechanism trash bag device of the present invention while open in accordance with the disclosed architecture;

FIG. 3 illustrates a front view of one potential embodiment of a retention and sealing mechanism trash bag device of the present invention while closed in accordance with the disclosed architecture;

FIG. 4 illustrates a front view of one potential embodiment of a retention and sealing mechanism trash bag device of the present invention while open and secured to a trash receptacle in accordance with the disclosed architecture; and

FIG. 5 illustrates a flowchart of a method of using one potential embodiment of a retention and sealing mechanism trash bag device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a retention and sealing mechanism trash bag device that prevents slippage of the bag into the receptacle during use. There also exists a long-felt need in the art for a retention and sealing mechanism trash bag device that facilitates reliable and hygienic sealing of the bag during removal. Moreover, there exists a long-felt need in the art for a retention and sealing mechanism trash bag device that enhances user convenience and waste containment.

The present invention, in one exemplary embodiment, is comprised of a retention and sealing mechanism trash bag device. The device is a trash bag designed to attach securely to the rim of a trash receptacle and to enable efficient sealing upon removal. This configuration enhances convenience, hygiene, and waste management. The device is comprised of a trash bag body, which is further comprised of a retention and sealing mechanism that maintains secure attachment to the receptacle and enables cinching to close the bag.

The retention and sealing mechanism includes an elastic band, with a first end routed through a locking member configured to hold the band at a selected tension. During installation, the band is tightened through the locking member, compressing the trash bag body against the receptacle rim to prevent displacement. During removal, the band is further tightened to cinch the bag's opening and seal its contents. Additionally, the mechanism may be used as a grip aid to assist with extraction. Once removed, the trash bag may optionally be tied for further closure.

In one embodiment, a section of the elastic band is externally affixed to the trash bag body using a fastener, which may be comprised of a bonding agent, thermal seal, adhesive, or mechanical stitching. In another embodiment, the elastic band is routed through an internal pocket positioned along the periphery of the trash bag body. The pocket includes exit openings that allow access to the locking member and the band's end.

The invention also includes a method of use comprising the steps of providing the trash bag with an integrated retention and sealing mechanism, positioning the bag within a trash receptacle, tensioning the band through the locking member to secure the bag, cinching the opening during removal to seal the contents, using the mechanism for gripping and extraction, and optionally tying the bag shut after removal.

As a result, the device provides key advantages by preventing the bag from collapsing into the receptacle and enabling a controlled, hygienic sealing process during removal. The combination of the elastic band and locking member further delivers an adjustable and reliable fit across various receptacle shapes, reducing the need for repositioning and improving user interaction. The ability to seal the bag at the point of removal minimizes odor release and potential waste exposure, promoting improved hygiene and safety. Through integration of these features, the trash bag device addresses limitations associated with existing trash bags known in the art.

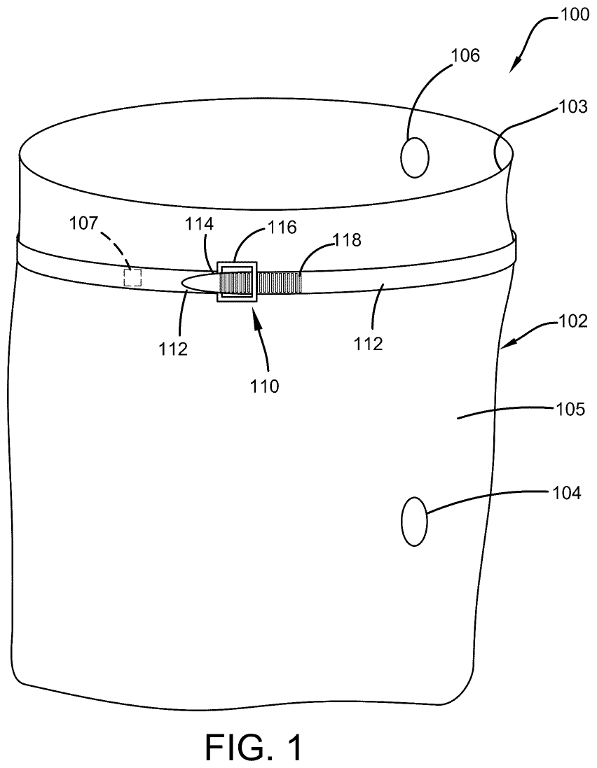

Referring initially to the drawings, FIG. 1 illustrates a front view of one potential embodiment of a retention and sealing mechanism trash bag device 100 of the present invention while open in accordance with the disclosed architecture. The device 100 is a trash bag designed to provide secure retention around a trash receptacle 101 rim and enable efficient sealing during removal and disposal. As a result, the device 100 enhances user convenience, hygiene, and waste management efficiency by integrating structural and functional features directly into the design of a trash bag.

The device 100 is comprised of a trash bag body 102. The body 102 may be any shape such as but not limited to cylindrical, rectangular, oval, or irregular polygonal profiles depending on the form factor of the trash receptacle 101. The body 102 may be made from materials such as but not limited to any combination of low-density polyethylene, high-density polyethylene, compostable biopolymer blends, or recycled plastic film.

In one embodiment, the body 102 may be impregnated with a scenting agent 104. The scenting agent 104 may be comprised of any combination of citrus, lavender, pine, eucalyptus, or charcoal-based neutralizers. In another embodiment, the body 102 may be comprised of an antimicrobial treatment 106 such as but not limited to silver-ion coatings or organic biocidal films applied to the body 102.

The body 102 is further comprised of a retention and sealing mechanism 110. The mechanism 110 is configured to both secure the device 100 to the rim of a trash receptacle 101 and enable cinching of the device 100 during removal. In one embodiment, the mechanism 110 is comprised of an elastic band 112. The elastic band 112 may be made from materials such as but not limited to any combination of natural rubber, silicone elastomers, thermoplastic elastomers, or stretchable polyurethane blends. The elastic band 112 may exhibit elastic recovery properties that enable repeated stretching and tightening without material degradation.

A first end 114 of the elastic band 112 may be routed through a locking member 116 on the opposing end of the band 112, a seen in FIG. 1. The locking member 116 is configured to retain the band 112 at a desired tension around the trash receptacle 101. The locking member 116 may be comprised of but is not limited to a unidirectional ratcheting mechanism, a friction-lock housing, or a toothed engagement path that permits forward movement of the end 114 through the locking member 116 while resisting reverse motion. In one embodiment, the elastic band 112 may be further comprised of a tactile member 118 such as but not limited to any combination of ridges or protrusions that may engage with the locking member 116 to prevent slippage of the end 114 rearward from the member 116 after the desired tension level is achieved around the trash receptacle 101.

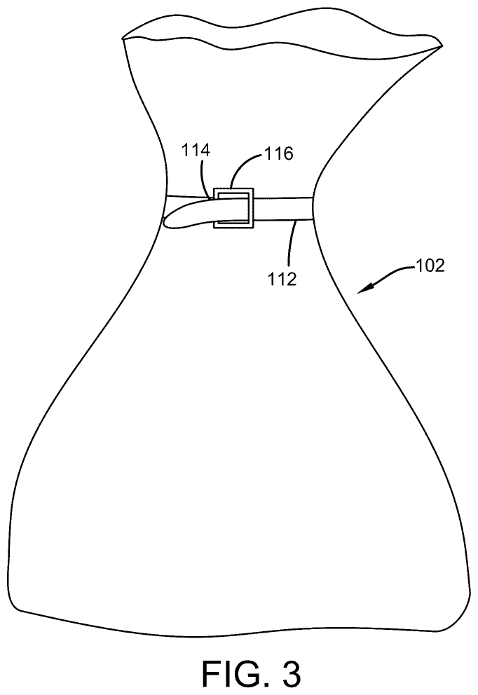

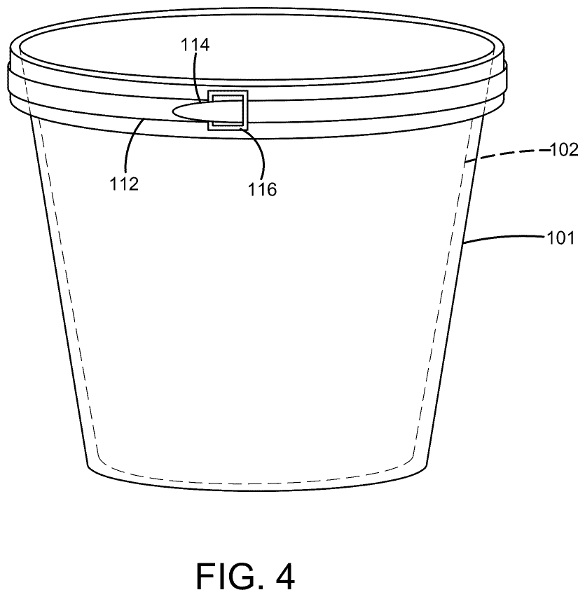

During installation, the mechanism 110 may be tightened around the trash receptacle 101 by pulling the end 114 through the locking member 116 to apply radial compression to the body 102. This engagement ensures the body 102 remains in fixed position on the receptable 101 during use and cannot fall into the receptable, as seen in FIG. 4. Upon removal of the body 102 from the receptable 101, the user may further cinch the opening 103 of the body 102 by pulling the end 114 further through the locking member 116 (as seen in FIG. 3), thereby sealing the contents of the body 102. In one embodiment, the user may utilize the mechanism 110 as a gripping aid for extracting the device 100 from the receptacle 101 while simultaneously initiating the sealing action. Following removal, the body 102 may optionally be tied shut.

In one embodiment, a portion of the mechanism 110, such as but not limited to a portion of the band 112, may be externally affixed to the outer surface 105 of the body 102 using a fastener 107, as seen in FIG. 1. The fastener 107 may be comprised of but not limited to a bonding agent, a thermal seal, an adhesive, or a mechanical stitching method.

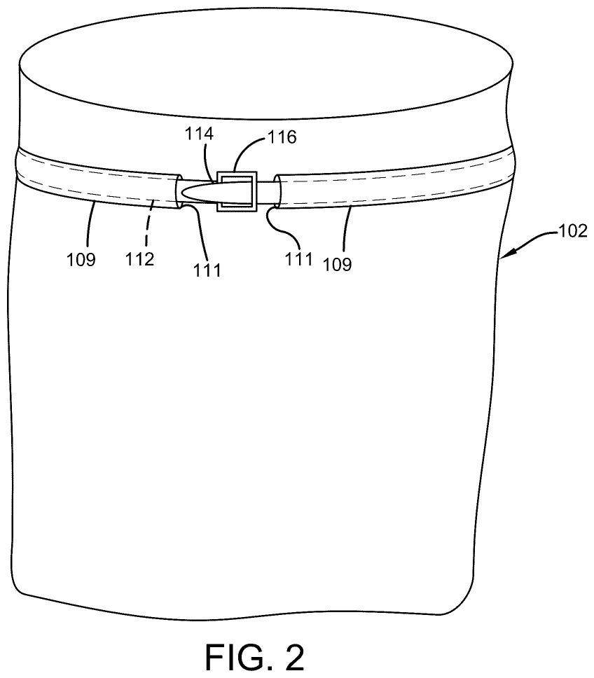

In another embodiment, the elastic band 112 may be routed through an internal pocket 109 formed integrally along the periphery of the body 102, as seen in FIG. 2. The internal pocket 109 may be comprised of a tubular sleeve. The pocket 109 may include opposing exit openings 111 configured to allow the locking member 116 and the first end 114 of the band 112 to protrude for user access. This arrangement provides a protected channel that prevents entanglement of the band 112 and preserves the aesthetic and functional profile of the device 100.

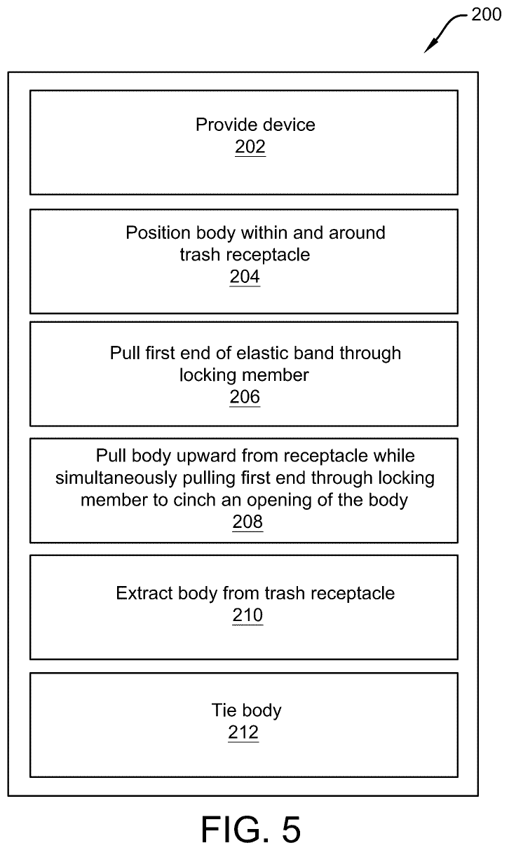

The present invention is also comprised of a method of using 200 the device 100, as seen in FIG. 5. First, a device 100 is provided comprised of a bag body 102 comprised of a retention and sealing mechanism 110 comprised of an elastic band 112 having a first end 114 that can be routed through a locking member 116 [Step 202]. Then, the body 102 is positioned within a trash receptacle 101 such that an upper portion of the body 102 surrounds the rim of the trash receptacle 101, as seen in FIG. 3 [Step 204]. Next, the first end 114 of the elastic band 112 is pulled through the locking member 116 until the body 102 is radially compressed against the trash receptacle 101, thereby securing the device 100 to the receptacle 101 [Step 206]. Then, upon filling of the body 102 with waste and initiation of removal, the user pulls the body 102 upward from the receptable (such that the mechanism 110 no longer contacts the receptable 101) via the body 102 and/or the mechanism 110 while simultaneously pulling the first end 114 through the locking member 116 to cinch the opening 103 of the body 102 (as seen in FIG. 4), thereby sealing the contents within the body 102 [Step 208]. Next, the user may grip the mechanism 110 and extract the body 102 from the receptacle 101 while maintaining the sealed configuration [Step 210]. Finally, the body 102 may optionally be tied shut following removal to further secure the waste prior to disposal [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “retention and sealing mechanism trash bag device” and “device” are interchangeable and refer to the retention and sealing mechanism trash bag device 100 of the present invention.

Notwithstanding the foregoing, the retention and sealing mechanism trash bag device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the retention and sealing mechanism trash bag device 100 as shown in the FIGS. are for illustrative purposes only, and that many other sizes and shapes of the retention and sealing mechanism trash bag device 100 are well within the scope of the present disclosure. Although the dimensions of the retention and sealing mechanism trash bag device 100 are important design parameters for user convenience, the retention and sealing mechanism trash bag device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A retention and sealing mechanism trash bag device comprising:
a trash bag body comprised of an opening and a retention and sealing mechanism attached to the trash bag body, wherein the retention and sealing mechanism is comprised of an elastic band having a first end and a locking member that receives and retains the first end.

2. The retention and sealing mechanism trash bag device of claim 1, wherein the trash bag body is comprised of an antimicrobial treatment.

3. The retention and sealing mechanism trash bag device of claim 2, wherein the antimicrobial treatment is comprised of a silver-ion coating or an organic biocidal film.

4. The retention and sealing mechanism trash bag device of claim 1, wherein the locking member is comprised of a unidirectional ratcheting mechanism, a friction-lock housing, or a toothed engagement path.

5. The retention and sealing mechanism trash bag device of claim 1, wherein the elastic band is comprised of a ridge or a protrusion.

6. The retention and sealing mechanism trash bag device of claim 1, wherein the trash bag body is comprised of a pocket.

7. The retention and sealing mechanism trash bag device of claim 6, wherein the elastic band is positioned within the pocket.

8. The retention and sealing mechanism trash bag device of claim 7, wherein the trash bag body is comprised of a first opening and a second opening.

9. The retention and sealing mechanism trash bag device of claim 8, wherein the first end exits the pocket via the first opening.

10. The retention and sealing mechanism trash bag device of claim 8, wherein the locking member exits the pocket via the second opening.

11. A retention and sealing mechanism trash bag device comprising:
a trash bag body comprised of an opening, a scenting agent, and a retention and sealing mechanism attached to the trash bag body, wherein the retention and sealing mechanism is comprised of an elastic band comprised of a first end and a locking member that receives and retains the first end, wherein the locking member is opposite the first end.

12. The retention and sealing mechanism trash bag device of claim 11, wherein the scenting agent is comprised of a citrus, a lavender, a pine, a eucalyptus, or a charcoal-based neutralizer.

13. The retention and sealing mechanism trash bag device of claim 11, wherein the trash bag body is comprised of an antimicrobial treatment comprised of a silver-ion coating or an organic biocidal film.

14. The retention and sealing mechanism trash bag device of claim 11, wherein the locking member is comprised of a unidirectional ratcheting mechanism, a friction-lock housing, or a toothed engagement path.

15. The retention and sealing mechanism trash bag device of claim 11, wherein the elastic band is comprised of a ridge or a protrusion.

16. The retention and sealing mechanism trash bag device of claim 11, wherein the trash bag body is comprised of a pocket.

17. The retention and sealing mechanism trash bag device of claim 16, wherein the elastic band is positioned within the pocket.

18. The retention and sealing mechanism trash bag device of claim 17, wherein the trash bag body is comprised of a first opening and a second opening.

19. The retention and sealing mechanism trash bag device of claim 18, wherein the first end exits the pocket via the first opening and the locking member exits the pocket via the second opening.

20. A method of using a retention and sealing mechanism trash bag device, the method comprising the following steps:
providing a retention and sealing mechanism trash bag device comprised of a trash bag body and a retention and sealing mechanism attached to the trash bag body, the retention and sealing mechanism comprising an elastic band having a first end and a locking member;
positioning the trash bag body within a trash receptacle such that the trash bag body surrounds a rim of the trash receptacle;
pulling the first end of the elastic band through the locking member until the trash bag body is radially compressed against the trash receptacle; and
pulling the trash can body upward from the trash receptacle via the retention and sealing mechanism such that the retention and sealing mechanism no longer touches the trash receptacle, while simultaneously pulling the first end of the elastic band through the locking member to cinch an opening of the trash bag body closed.
